(19) United States
(12) Patent Application Publication
(10) Pub. No.: US 2014/0041002 A1
(43) Pub. Date: Feb. 6, 2014

(54) Secure Access Method, Apparatus And System For Cloud Computing

(71) Applicant: GUANGZHOU BINGO SOFTWARE CO., LTD., Guangzhou (CN)

(72) Inventors: Xin LIU, Guangzhou (CN); Longhao Yuan, Guangzhou (CN)

(73) Assignee: Guangzhou Bingo Software Co., Ltd., Guangzhou (CN)

(21) Appl. No.: 13/683,292

(22) Filed: Nov. 21, 2012

(30) Foreign Application Priority Data
Jul. 31, 2012 (CN) 201210271821.X

(51) Int. Cl. H04L 29/06

(52) U.S. Cl. CPC H04L 63/083
USPC 726/7

(57) ABSTRACT

Secure access method, apparatus and system for cloud computing are provided. The method includes: acquiring authentication information input from a client; determining a client identification of the client which is not arbitrarily changeable; if it is determined that the ordinary password corresponding to the user name is correct, determining by a distribution authentication server whether a correspondence between the client identification and the address of the cloud machine exists in a database of the distribution authentication server and whether the dynamic password is correct, and notifying the client of a successful login if the correspondence exists in the database and the dynamic password is correct, and notifying the client of an unsuccessful login if it is determined that the ordinary password corresponding to the user name is incorrect.

### CROSS REFERENCE TO RELATED APPLICATION

This application claims the priority of Chinese Patent Application No 201210271821.X, entitled “SECURE ACCESS METHOD, APPARATUS AND SYSTEM FOR CLOUD COMPUTING”, filed on Jul. 31, 2012 with State Intellectual Property Office of PRC, which is hereby incorporated by reference in its entirety.

### FIELD OF THE INVENTION

The present invention relates to the field of communication technology, and in particular to a secure access method, apparatus and system for cloud computing.

### BACKGROUND OF THE INVENTION

Cloud computing is an Internet-based computing method, through which shared hardware and software resources and information can be provided to computers or other devices as required. A cloud platform provides cloud-computing-based services. Since the cloud platform is provided by a provider, customers, who enjoy services of the cloud platform, may create a new mirror instance depending on the cloud platform without constructing, their own infrastructure.

In a specific cloud computing service, the infrastructure of the provider can conveniently provide users with cloud machines. A user can access the cloud machine through a remote connection tool, like accessing a real physical machine. When the user logs into the cloud machine via a client, the user needs to provide to the server a user name, a password and a host IP address of the cloud machine to be logged in. The server needs to determine whether the user name and the password are correct. If the user name and the password are correct, the user is allowed to access the cloud machine corresponding to the input host IP address; if the user name or the password is incorrect, the client is notified that the user name or the password is wrong and is not allowed to access the cloud machine.

In the study and practice of the prior art, the following drawback comes to the attention of the inventors of the present invention:

Regardless of some extent of security achieved by the existing method for logging in the cloud machine, illegal users may have the permission to log in the cloud machine if the user name and the password of the client are leaked out or stolen during transmission. Therefore, the login method for the cloud machine in the prior art has poor security.

Hence, how to ensure the security for logging in the cloud machine by the client has become the urgent problem.

### SUMMARY OF THE INVENTION

An object of the present invention is to provide a secure access method, apparatus and system for cloud computing, which may avoid the possibility that an illegal user acquires permission to log in a cloud machine by stealing the password, thereby the security for logging in the cloud machine is improved.

The embodiments of the present invention are as follows.

A secure access method for cloud computing, includes:

acquiring authentication information input from a client, the authentication information including a user name, an ordinary password, a dynamic password and an address of a cloud machine to be accessed;

determining a client identification of the client which is not arbitrarily changeable;

if it is determined that the ordinary password corresponding to the user name is correct, determining, by a distribution authentication server, whether a correspondence between the client identification and the address of the cloud machine exists and whether the dynamic password is correct, and notifying the client of a successful login and allowing the client to access the cloud machine if the correspondence exists in the database and the dynamic password is correct, or notifying the client of an unsuccessful login if the correspondence does not exist in the database or the dynamic password is incorrect; and

if it is determined that the ordinary password corresponding to the user name is incorrect, notifying the client of an unsuccessful login.

Preferably, in the above mentioned secure access method for cloud computing, the dynamic password is generated with a password seed pre-allocated to the client by the distribution authentication server, and the dynamic password is periodically updated via the password seed.

Preferably, in the above mentioned secure access method for cloud computing, the ordinary password is formed by digitals, characters or a combination thereof.

Preferably, in the above mentioned secure access method for cloud computing, the client identification is a CPU identification.

Preferably, in the above mentioned secure access method for cloud computing, the client identification is a unique identification of main board.

A secure access apparatus for cloud computing, includes:

an acquiring module adapted for acquiring authentication information input from a client, the authentication information including a user name, an ordinary password, a dynamic password and an address of a cloud machine to be accessed;

a determining module adapted for determining a client identification of the client, the client identification being not arbitrarily changeable;

a first decision module adapted for determining whether the ordinary password corresponding to the user name is correct, and for notifying the client of an unsuccessful login via a sending module if the ordinary password corresponding to the user name is incorrect;

a second decision module adapted for determining, via a distribution authentication server, whether a correspondence between the client identification and the address of the cloud machine exists in a database of the distribution authentication server and whether the dynamic password is correct when it is determined by the first decision module that the ordinary password corresponding, to the user name is correct, and for notifying the client of a successful login via the sending module and allowing the client to access the cloud machine if the correspondence exists in the database and the dynamic password is correct, or for notifying the client of an unsuccessful login via the sending module if the correspondence does not exist in the database or the dynamic password is incorrect; and

the sending module adapted for sending information of the successful login or the unsuccessful login to the client.

A secure access system for cloud computing, includes a cloud machine and a distribution authentication server, wherein:

the cloud machine is adapted for acquiring authentication information, which comprises a user name, an ordinary password, a dynamic password and an address of a cloud machine to be accessed, input from a client; for determining a client identification of the client which is unchangeable by the client; for determining whether the ordinary password corresponding to the user name is correct; and for sending the address of the cloud machine and the dynamic password to the distribution authentication server if the ordinary password corresponding to the user name is correct, or notifying the client of an unsuccessful login if the ordinary password corresponding to the user name is incorrect; and

the distribution authentication server is adapted for determining whether a correspondence between the client identification and the address of the cloud machine exists in a database of the distribution authentication server and whether the dynamic password is correct; and for notifying the client of a successful login and allowing the client to access the cloud machine if the correspondence exists in the database and the dynamic password is correct, or notifying the client of an unsuccessful login if the correspondence does not exist in the database or the dynamic password is incorrect.

Compared with the prior art, the technical solution provided by the embodiment has the following advantages and features.

In the solution according to the present invention, the correspondence between the client identification and the, address of the cloud machine is pre-established in the database of the distribution authentication server, and it is determined whether data of the correspondence between the client identification and the address of the cloud machine provided by the client presents in the database. Both the client identification and the address of the cloud machine are unique, therefore it can be determined whether the association between the current client and the address of the cloud machine is pre-established and stored in the database as long as the client identification and the address of the cloud machine are obtained. Even if an illegal user steals the user name and the password information, the illegal user can not falsify his/her client identification, and therefore the correspondence between the client identification of the illegal user and the address of the cloud machine, can not be stored in the database. Hence, it is avoided that the illegal user acquires permission for logging in the cloud machine by stealing the password, and the security for the login of the cloud machine is improved.

### BRIEF DESCRIPTION OF THE DRAWINGS

Technical solutions of the embodiments of the present applicant or the prior art will be illustrated more clearly with the following brief description of the drawings. Apparently, the drawings referred in the following description constitute only some embodiments of the invention. Those skilled in the art may obtain some other drawings from these drawings without any creative work.

FIG. 1 is a flow chart of a secure access method for cloud computing according to the present invention;

FIG. 2 is a block diagram of a secure access apparatus for cloud computing according to the present invention;

FIG. 3 is a block diagram of a secure access system for cloud computing according to the present invention;

FIG. 4 is a diagram showing the signaling in a process to establish association between a client and a cloud machine according to the present invention; and

FIG. 5 is a diagram showing the signaling in a process to verify the association between the client and the cloud machine according to the present invention.

### DETAILED DESCRIPTION OF THE INVENTION

The technical solution according to the embodiments of the present invention will be described clearly and completely as follows in conjunction with the drawings. It is obvious that the described embodiments are only some rather than all embodiments according to the present invention. Any other embodiments obtained by those skilled in the art based on the embodiments of the present disclosure without any creative work fall within the scope of the present invention.

An embodiment of the present invention provides a secure access method for cloud computing, including: acquiring authentication information input from a client, the authentication information including a user name, an ordinary password, a dynamic password and an address of a cloud machine to be accessed; determining a client identification of the client which is not arbitrarily changeable; if it is determined that the ordinary password corresponding to the user name is correct, determining by a distribution authentication server whether a correspondence between the client identification and the address of the cloud machine exists in a database of the distribution authentication server and whether the dynamic password is correct, and notifying the client of a successful login and allowing the client to access the cloud machine if the correspondence exists in the database and the dynamic password is correct, or otherwise notifying the client of an unsuccessful login; and if it is determined that, the ordinary password corresponding to the user name is incorrect, notifying the client of an unsuccessful login.

There are many ways to implement the above mentioned secure access method for cloud computing. The following description will be made with reference to a specific embodiment.

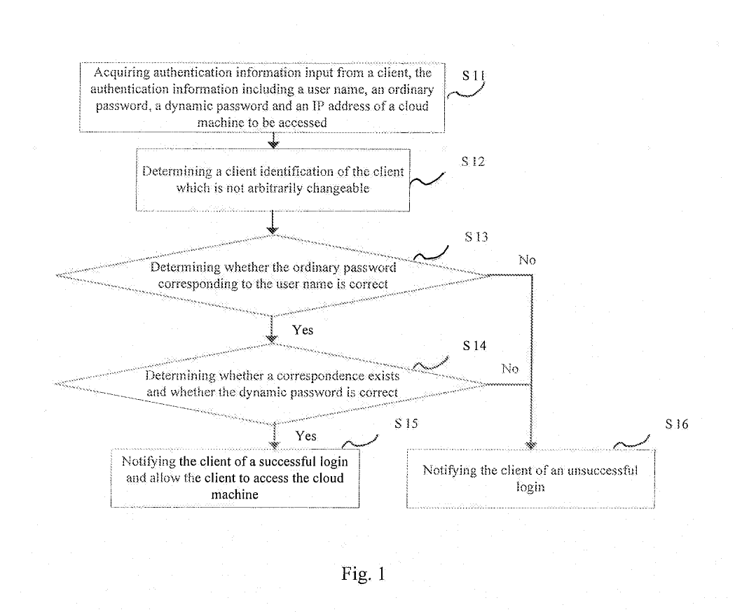

Referring to FIG. 1, a flow chart of a secure access method for cloud computing is shown, which includes the following steps.

Step S11: acquiring authentication information input from a client, the authentication information including a user name, an ordinary password, a dynamic password and an IP address of a cloud machine to be accessed.

The user name, the ordinary password, the dynamic password and the IP address of the cloud machine to be accessed are all manually entered by a user and are acquired.

The ordinary password is an existing password; the dynamic password is generated with a password seed pre-allocated to the client by the distribution authentication server, and the dynamic password is periodically updated via the password seed. The dynamic password may change over time, as the password seed updates the dynamic password at pre-determined intervals.

Step S12: determining a client identification of the client which is not arbitrarily changeable.

The client identification may be a CPUID, i.e., a processor identification, MAC address of a network card, an unique identification of a main board, or an unique identification of a designated chip. The client identification must be unique and can not be changed by the user. Therefore, in the present invention, it is preferable to use the processor identification which is a default setting made by the manufacture and is unchangeable at will

Step S13: determining whether the ordinary password corresponding to the user name is correct, proceeding to Step S14 if the ordinary password is correct or proceeding to Step S16 if the ordinary password is incorrect.

At first it is needed to determine whether the ordinary password corresponding to the user name is correct. The subsequent determination would be performed in the case that the ordinary password corresponding to the user name is correct; and the client would be notified of an unsuccessful login in the case that the user name and the ordinary password are incorrect.

Step S14: determining, by a distribution authentication server, whether a correspondence between the client identification and the address of the cloud machine exists in a database of the distribution authentication server and whether the dynamic password is correct, and proceeding to Step S15 if the correspondence exists and the dynamic password is correct, or proceeding to Step S16 if the correspondence does not exist or the dynamic password is incorrect.

The correspondence between each of the client identifications and respective one of the IP addresses of the cloud may is pre-stored in the database. Subsequently it may be checked in the pre-established database whether a correspondence between the currently input IP address of the cloud machine and the determined client identification exists. Moreover, it is also determined whether the dynamic password is correct. The client is determined as a legal user if the correspondence exists and the dynamic password is correct, or the client is determined as an illegal user if the correspondence does not exist or the dynamic password is incorrect.

Step S15: notifying the client of a successful login and allowing the client to access the cloud machine.

Step S16: notifying the client of an unsuccessful login.

In the embodiment shown in FIG. 1, the correspondence between the client identification and the address of the cloud machine is pre-established in the database of the distribution authentication server, and it is determined whether data of the correspondence between the client identification and the address of the cloud machine provided by the client presents in the database. Both the client identification and the address of the cloud machine are unique, therefore it can be determined Whether the association between the current client and the address of the cloud machine is pre-established and stored in the database as long as the client identification and the address of the cloud machine are obtained. Moreover, the dynamic password is used for security. Even if an illegal user steals the user name and the password information, the illegal user can not falsify his/her client identification, and therefore the correspondence between the client identification of the illegal user and the address of the cloud machine can not be stored in the database. Hence, it is avoided that the illegal user acquires permission for logging in the cloud machine by stealing the password, and the security for the login of the cloud machine is improved.

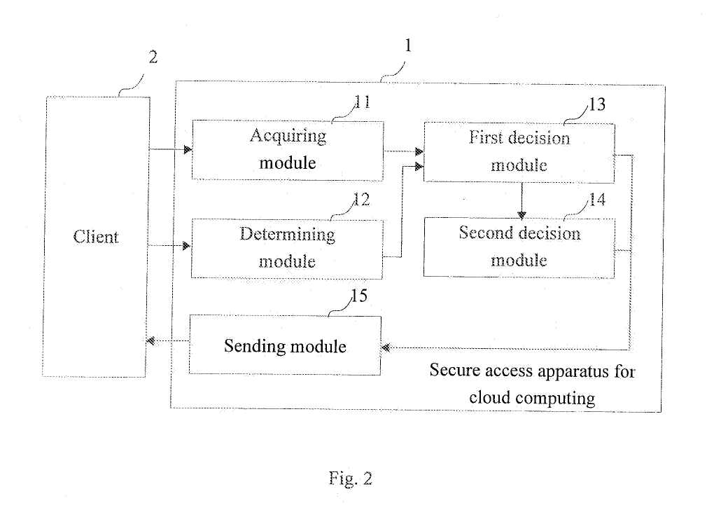

Referring to FIG. 2, a block diagram of a secure access apparatus 1 for cloud computing is shown, which includes: an acquiring module 11 adapted for acquiring authentication information input from a client 2, the authentication information including a user name, an ordinary password, a dynamic password and an address of a cloud machine to be accessed; a determining module 12 adapted for determining a client identification of the client 2, the client, identification being not arbitrarily changeable; a first decision module 13 adapted for determining whether the ordinary password corresponding to the user name is correct, and for notifying the client 2 of an unsuccessful login via a sending module 15 if the ordinary password corresponding to the user name is incorrect; a second decision module 14 adapted for determining, via a distribution authentication server, whether a correspondence between the client identification and the address of the cloud machine exists in a database of the distribution authentication server and whether the dynamic password is correct when it is determined by, the first decision module 13 that the ordinary password corresponding to the user name is correct, and for notifying the client 2 of a successful login via the sending module 15 and allowing the client 2 to access the cloud machine if the correspondence exists in the database and the dynamic password is correct, or for notifying the client 2 of an unsuccessful login via the sending module 15 if the correspondence does not exist in the database or the dynamic password is incorrect; and the sending module 15 adapted for sending information of the successful login or the unsuccessful login to the client 2.

In the embodiment shown in FIG. 2, the secure access apparatus 1 for cloud computing corresponds to the above described method. Therefore, for the contents about each part of the secure access apparatus 1 for cloud computing, reference can be made to the contents of the above mentioned method.

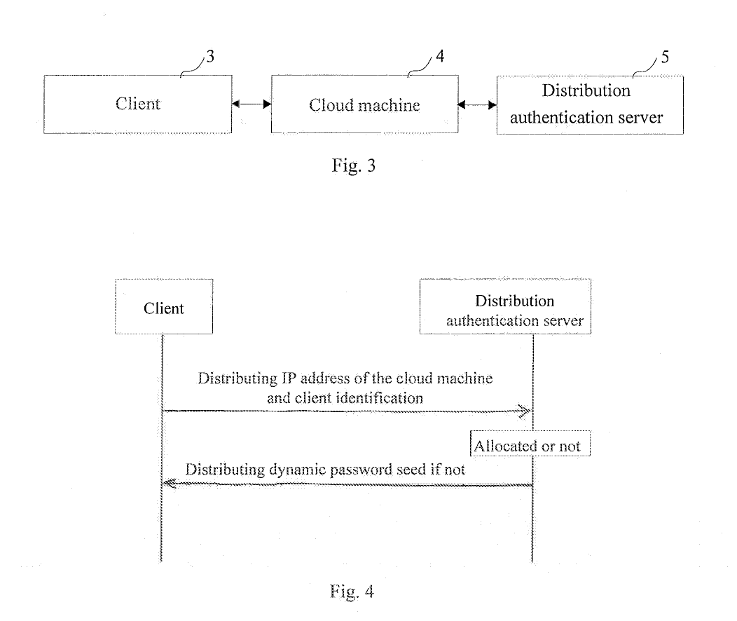

Referring to FIG. 3, a block diagram of a secure access system for cloud computing is shown, which includes a cloud machine 4 and a distribution authentication server 5. The cloud machine 4 is adapted for acquiring authentication information, which includes a user name, an ordinary password, a dynamic password and an address of a cloud machine 4 to be accessed, input from a client 3; for determining a client identification of the client 3 which is not arbitrarily changeable; for determining whether the ordinary password corresponding to the user name is correct; and for sending the address of the cloud machine 4 and the dynamic password to the distribution authentication server 5 if the ordinary password corresponding to the user name is correct, or notifying the client 3 of an unsuccessful login if the ordinary password corresponding to the user name is incorrect. The distribution authentication server 5 is adapted for determining whether a correspondence between the client identification and the address of the cloud machine 4 exists and whether the dynamic password is correct; and for notifying the client 3 of a successful login and allowing the client 3 to access the cloud machine 4 if the correspondence exists and the dynamic password is correct, or notifying the client 3 of an unsuccessful login if the correspondence does not exist or the dynamic password is incorrect.

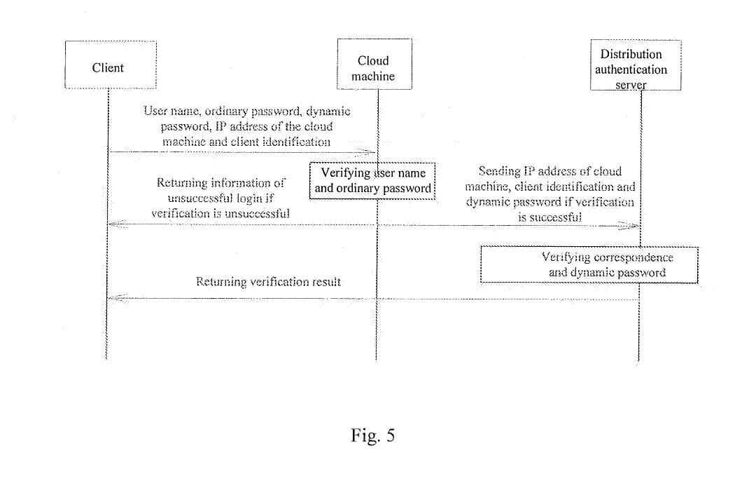

For better illustration of the technical solution according to the present invention, the following description will be made by way of examples. References are made to FIGS. 4 and 5. FIG. 4 shows a process to establish association between a client and a cloud machine, and FIG. 5 shows a process to verify the association between the client and the cloud machine.

Referring to FIG. 4, for confining that only the designated clients have access to the cloud machines, during the authentication for logging in the cloud machine, it is desired to determine whether the client that performs the login is a legal client. The client needs to send out distribution request together with his/her client identification and the IP address of the cloud machine to be logged in. The distribution authentication server needs to determine whether a dynamic password seed has been allocated to the client. If a dynamic password seed hasn't been allocated to the client yet, the distribution authentication server stores the relationship between the client identification of the current client and the IP address of the cloud machine, establishes a correspondence and returns the dynamic, password seed back to the client.

Still referring to FIG. 5, except for the verification of the user name and the ordinary password, it is further verified whether the specified client is legal. That is to say, there is a correspondence between the target cloud machine and the specified client. What is needed to do is to establish this correspondence and verify this correspondence. A server which provides this kind of service is referred to as a distribution authentication server. Firstly, the client sends a user name, an ordinary password, a dynamic password generated with the password seed, a client identification and an IP address of the cloud machine to the cloud machine. The cloud machine verifies the user name and the ordinary password. The cloud machine sends the IP address of the cloud machine, the client identification and the dynamic password to the distribution authentication server if the verification is successful, or the cloud machine sends information of unsuccessful verification to the client if the verification is unsuccessful. After receiving the IP address of the cloud machine and the client identification, the distribution authentication server checks in the database whether a correspondence between the IP address of the cloud machine and the client identification exists and verifies whether the dynamic password is correct. If the correspondence exists and the dynamic password is correct, the authentication is passed and information of a successful login is returned. Otherwise the authentication is failed and information of an unsuccessful login is returned.

Furthermore, the full term for the expression “cloud machine” throughout the present disclosure is “Machine Instance in Cloud” or “protected machine”. This expression doest not intended to refer particularly to be in the cloud. For convenience, the protected machine is referred to as the cloud machine.

It is noted that the embodiments shown in FIGS. 1-5 are only the preferred embodiments of the present invention. Additional embodiments may occur to those skilled in the art from these embodiments and will not be described in detail herein.

Numerous modifications to the embodiments will he apparent to those skilled in the art, and the general principle herein can be implemented in other embodiments without deviation from the spirit or scope of the present invention. Therefore, the present invention will not be limited to the embodiments described herein, but has the widest scope that is conformity with the principle and the novel features disclosed herein.

What is claimed is:

1. A secure access method for cloud computing, comprising:
acquiring authentication information input from a client, the authentication information comprising a user name, an ordinary password, a dynamite password and an address of a cloud machine to be accessed;
determining a client identification of the client which is not arbitrarily changeable;
if it is determined that the ordinary password corresponding to the user name is correct, determining, by a distribution authentication server, whether a correspondence between the client identification and the address of the cloud machine exists in a database of the distribution authentication server and whether the dynamic password is correct, and notifying the client of a successful login and allowing the client to access the cloud machine if the correspondence exists in the database and the dynamic password is correct, or notifying the client of an unsuccessful login if the correspondence does not exist in the database or the dynamic password is incorrect; and
if it is determined that the ordinary password corresponding to the user name is incorrect, notifying the client of an unsuccessful login.

2. The secure access method for cloud computing according to claim 1, wherein the dynamic password is generated with a password seed pre-allocated to the client by the distribution authentication server, and the dynamic password is periodically updated via the password seed.

3. The secure access method for cloud computing according to claim 1, wherein the ordinary password is formed by digitals, characters or a combination thereof.

4. The secure access method for cloud computing according to claim 1, wherein the client identification is a CPU identification.

5. The secure access method for cloud computing according to claim 1, wherein the client identification is a unique identification of main board.

6. A secure access apparatus for cloud computing, comprising:
an acquiring module adapted for acquiring authentication information input from a client, the authentication information comprising a user name, an ordinary password, a dynamic password and an address of a cloud machine to be accessed;
a determining module adapted for determining a client identification of the client, the client identification being not arbitrarily changeable;
a first decision module adapted for determining whether the ordinary password corresponding to the user name is correct, and for notifying the client of an unsuccessful login via a sending module if the ordinary password corresponding to the user name is incorrect;
a second decision module adapted for determining, via a distribution authentication server, whether a correspondence between the client identification and the address of the cloud machine exists in a database of the distribution authentication server and whether the dynamic password is correct when it is determined by the first decision module that the ordinary password corresponding to the user name is correct, and for notifying the client of a successful login via the sending module and allowing the client to access the cloud machine if the correspondence exists in the database and the dynamic password is correct, or for notifying the client of an unsuccessful login via the sending module if the correspondence does not exist in the database or the dynamic password is incorrect; and
the sending module adapted for sending information of the successful login or the unsuccessful login to the client.

7. A secure access system for cloud computing, comprising a cloud machine and a distribution authentication server, wherein:
the cloud machine is adapted for acquiring authentication information, which comprises a user name, an ordinary password, a dynamic password and an address of a cloud machine to be accessed, input from a client; for determining a client identification of the client which is not arbitrarily changeable; for determining whether the ordinary password corresponding to the user name is correct; and for sending the address of the cloud machine and the dynamic password to the distribution authentication server if the ordinary password corresponding to the user name is correct, or notifying the client of an unsuccessful login if the ordinary password corresponding to the user name is incorrect; and
the distribution authentication server is adapted for determining whether a correspondence between the client identification and the address of the cloud machine exists in a database of the distribution authentication server and whether the dynamic password is correct; and for notifying the client of a successful login and allowing the client to access the cloud machine if the correspondence exists in the database and the dynamic password is correct, or notifying the client of an unsuccessful login if the correspondence does not exist in the database or the dynamic password is incorrect.
